(19) United States
(12) Patent Application Publication
(10) Pub. No.: US 2006/0091677 A1
(43) Pub. Date: May 4, 2006

(54) Electric power plant

(76) Inventor: Geoffrey B. Greene, Memphis, TN (US)

Correspondence Address: Geoffrey B. Greene, 4066 Clearpool Cir Rd., Memphis, TN, 38118, US

(21) Appl. No.: 10/980,581

(22) Filed: Nov. 3, 2004

(51) Int. Cl. F03B 13/00; H02P 9/04

(52) U.S. Cl. 290/54

(57) ABSTRACT

An electric power plant that will tap power from a moving water current and convert it into useable electricity.

### CROSS-REFERANCE TO RELATED APPLICATION

Not applicable

### BACKGROUND

1. Field of Invention

This invention relates to powering an electric generator using water current instead of darned up water preasure.

2. Description of Prior Art

Originally Hydro electric power plants used the power of falling water to power terbins this method works very well if you have falling terain. If there is not at least around twelve feet of fall a terbin will not spin fast enough to power a generator.

### SUMMARY

In accordance with the present invention an electric power plant that will tap power from a moving water current and convert it into useable electricity.

### OBJECTS AND ADVANTAGES

Accordingly, besides the advantages of tapping power from water current described in my patent application above several objects and advantages of the present invention are:

(a) no dam in a river needed that would stop fish

(b) no emmisions to foul the air or water

(c) good remote power supply

(d) mobile power

(e) free energy supply

(f) economical to construct and run

(g) good for on or off grid applications

(h) very low noise polution

Further objectives and advantages of my invention will become apparent from a consideration of the drawings and ensuing description.

### DRAWING FIGURES

FIG. 1 is a top view of floating unit 17 and floating unit 18

FIG. 2 is an elevation view of the of the tanks used to convert the energy into useable power inorder to spin a generator.

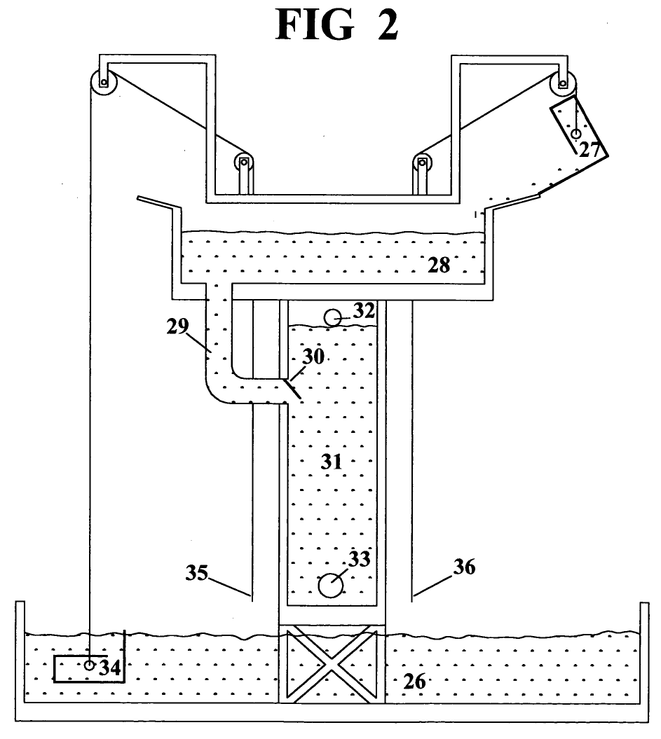

FIG. 3 is a perspective view floating unit 17 or floating unit 18

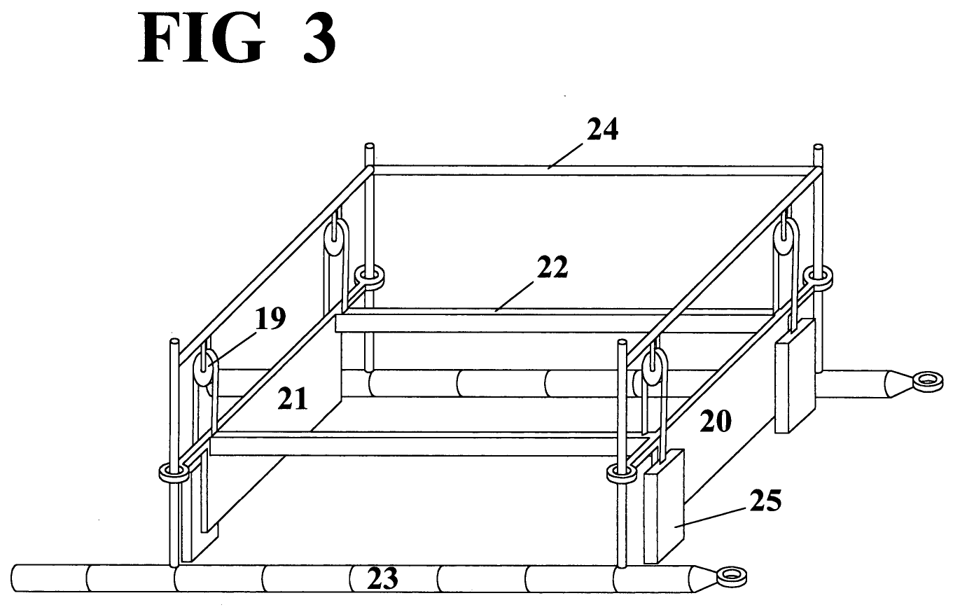

### REFERENCE NUMERLS IN DRAWING

17 FLOATING UNIT pulls on CABLE 37
18 FLOATING UNIT pulls on CABLE 37
19 POWER UNIT raises or lowers WATER SAIL'S 20 and 21
20 WATER SAIL taps water current power
21 WATER SAIL taps water current power
22 FRAME connects WATER SAIL 20 and WATER SAIL 21
23 PONTOON holds FRAME 24 up out of the water current
24 FRAME holds POWER UNIT 19 up out of the water current
25 COUNTER WEIGHT helps POWER UNIT 19 raise WATER SAIL 20 and 21
26 LOWER WATER TANK
27 MOVING WATER TANK is raised and lowered by CABLE 36
28 UPPER WATER TANK is alternatingly filled by MOVING WATER TANK 27 and MOVING WATER TANK 34
29 PIPE connects UPPER WATER TANK 28 and MID WATER TANK 31
30 FLOAT VALVE keeps water level constant in MID WATER TANK 31
31 MID WATER TANK provides water preasure to spin TURBIN 33
32 AIR VENT for MID WATER TANK 31
33 TURBIN powered by water in MID WATER TANK 31
34 MOVING WATER TANK is raised and lowered by CABLE 35
35 CABLE connects MOVING WATER TANK 34 to CABLE 37
36 CABLE connects MOVING WATER TANK 27 to CABLE 37

### DESCRIPTION AND OPERATION OV THE INVENTION

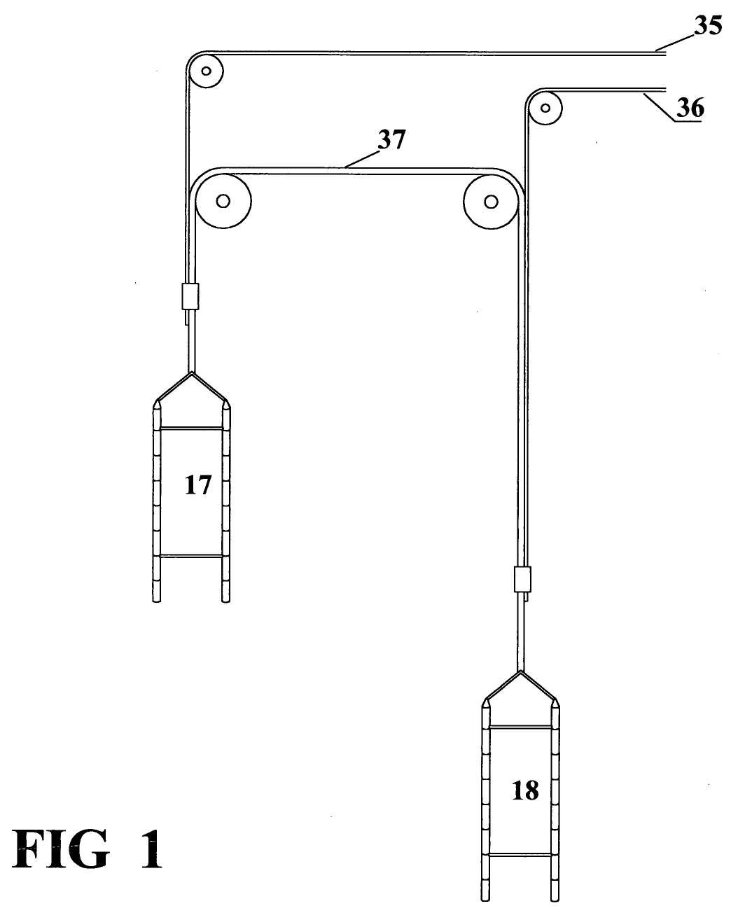

FIG. 1 shows a basic version of my invention by showing a top view of floating unit 17 and floating unit 18. Floating unit 17 has a water sail 21 that is lowered to tap the power of the water current that will push the floating unit 17 downstream with force.

That force inturn will pull floating unit 18 upstream by using cable 37. Then floating unit 17 can rais it's water sail 21 as floating unit 18 lowers it's water sail 21. This will cause floating unit 18 to go downstream and pull floating unit 17 upstream while pulling moving tank 27 up using cable 36. When floating unit 17 gets upstream and lowers it's water sail 21 it will inturn pull moving water tank 34 up using cable 35 as it does each cycle.

Each time moving tanks 27 and 34 alternatingly reach the bottom they fill with water from lower tank 26 and raise the water to upper tank 28 in a never ending alternating pattern.

Water falls through pipe 29 and float valve 30 into mid tank 31. Float valve 30 keeps mid tank 31 at a constant level while turbin 33 uses the preasurized water to spin an electric generator. The de preasurized water falls back to lower tank 26 to be recycled.

### CONCLUSIONS RAMIFICATOINS AND SCOPE

Accordingly, the reader will see that a pearson desiring to tap the power of a water current can do so without damming up the body of water. Simply use the high volume low preasuse water current to raise a smaller volume of water to increase it preasure to a desireable higher preasure on a very large scale or a small scale.

### SEQUENCE LISTING

Not applicable.

I claim:

1. a machine with the means to greatly condence the broad low preasure power of water current by using that high volume low preasure water to raise fluid to a higher elevation therefor increasing the preasure and lowering the area needed to harnes the energy from the water current.
